(19) United States
(12) Patent Application Publication
(10) Pub. No.: US 2004/0021289 A1
(43) Pub. Date: Feb. 5, 2004

(54) Multi-stage tube forging method for disproportionally enlarging an end section of a tube of a bicycle frame part

(76) Inventor: Ku Wu, Taichung Hsien (TW)

Correspondence Address: HARNESS, DICKEY & PIERCE, P.L.C., P.O. BOX 8910, RESTON, VA, 20195, US

(21) Appl. No.: 10/211,550

(22) Filed: Aug. 5, 2002

(51) Int. Cl. B62K 1/00

(52) U.S. Cl. 280/281.1

(57) ABSTRACT

A multi-stage tube forging method for disproportionally enlarging an end section of a tube of a bicycle frame part includes the steps of (a) radially and proportionally enlarging the cross-section of the end section of the tube in a first die using a first mandrel, and (b) disproportionally varying the cross-section of the end section of the tube obtained in step (a) in a second die using a second mandrel.

### BACKGROUND OF THE INVENTION

1. Field of the Invention

This invention relates to a multi-stage tube forging method for disproportionally enlarging an end section of a tube of a bicycle frame part.

2. Description of the Related Art

Conventionally, enlargement of an end section of a metal tube can be performed by extrusion, drawing, or forging. During tube forging, the end section of the tube is inserted in a shape-forming cavity of a die unit, and is forged by a mandrel to conform to an inner wall of the die unit at the shape-forming cavity. Various shapes of the end section of the tube can be formed via the tube forging method. However, conventional tube forging methods involve only a single-stage forging operation, i.e., the end section of the tube is formed into a desired shape in a single forging operation. As a consequence, in some cases, such as that shown in FIG. 1, the end section 21 of the tube 20 tends to break during forging operation when the same is disproportionally enlarged to a greater extent in one direction.

### SUMMARY OF THE INVENTION

Therefore, the object of the present invention is to provide a multi-stage tube forging method for disproportionally enlarging an end section of a tube that is capable of overcoming the aforesaid problem associated with the prior art.

Another object of this invention is to provide a bicycle frame part including a tube having an end section that is disproportionally enlarged according to the multi-stage tube forging method.

According to one aspect of the present invention, there is provided a multi-stage tube forging method for disproportionally enlarging an end section of a tube. The method comprises the steps of: (a) radially and proportionally enlarging the cross-section of the end section of the tube by forging the tube in a first die using a first mandrel; and (b) disproportionally varying the cross-section of the end section of the tube by forging the tube obtained in step (a) in a second die using a second mandrel in such a manner that a portion of the cross-section of the end section of the tube is reduced and the remaining portion of the cross-section of the end section of the tube is further enlarged. Preferably, the perimeter of an end edge of the end section of the tube obtained after step (b) is substantially equal to that of the end edge of the end section of the tube obtained after step (a) and before step (b).

According to another aspect of the present invention, there is provided a bicycle frame part including a tube having an end section that is disproportionally enlarged according to the multi-stage tube forging method comprising the steps of: (a) radially and proportionally enlarging the cross-section of the end section of the tube by forging the tube in a first die using a first mandrel; and (b) disproportionally varying the cross-section of the end section of the tube by forging the tube obtained in step (a) in a second die using a second mandrel in such a manner that a portion of the cross-section of the end section of the tube is reduced and the remaining portion of the cross-section of the end section of the tube is further enlarged. Preferably, the perimeter of an end edge of the end section of the tube obtained after step (b) is substantially equal to that of the end edge of the end section of the tube obtained after step (a) and before step (b).

### BRIEF DESCRIPTION OF THE DRAWINGS

In the drawings which illustrate an embodiment of the invention,

FIG. 1 is a perspective view to illustrate breakage of an end section of a tube when forged according to the conventional forging method;

FIG. 2 is a block diagram illustrating consecutive steps of a preferred embodiment of a multi-stage forging method of this invention for disproportionally enlarging an end section of a tube of a bicycle frame part;

FIG. 3 is a sectional view to illustrate how a tube is inserted into a first die according to the multi-stage forging method of this invention;

FIG. 4 is a sectional view to illustrate how the tube is forged via a first mandrel according to the multi-stage forging method;

FIG. 5 is a sectional view to illustrate the shape of an end section of the tube resulting from the forging operation shown in FIG. 4;

FIG. 6 is a sectional view to illustrate how the tube of FIG. 5 is inserted into a second die;

FIG. 7 is a sectional view to illustrate how the tube of FIG. 6 is subjected to a second forging operation via a second mandrel;

FIG. 8 is a sectional view to illustrate the shape of the end section of the tube resulting from the forging operation shown in FIG. 7; and

FIGS. 9 and 10 are perspective views to illustrate various shapes of the end section of the tube that can be formed according to the method of this invention.

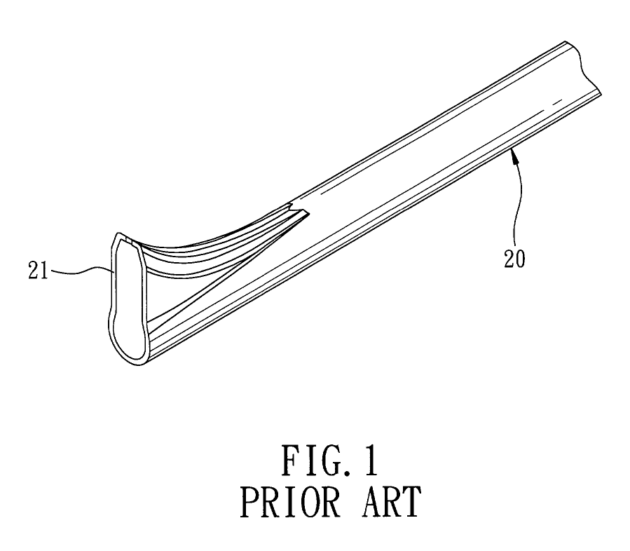

### DETAILED DESCRIPTION OF THE PREFERRED EMBODIMENT

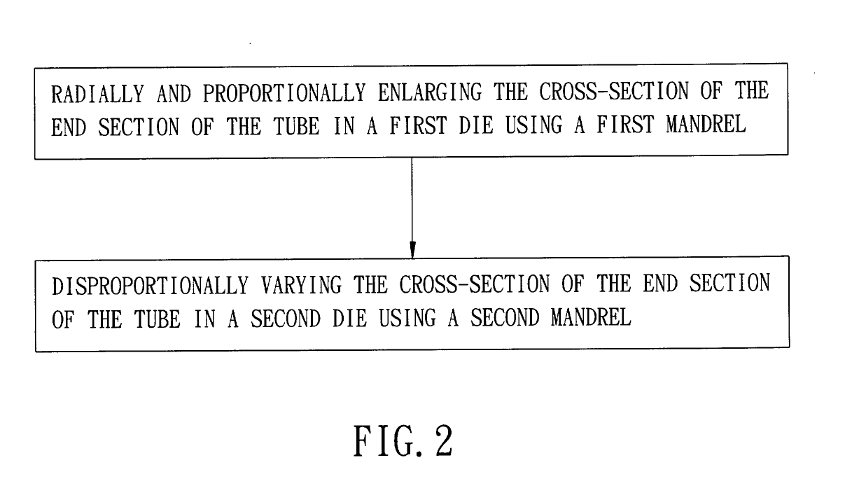

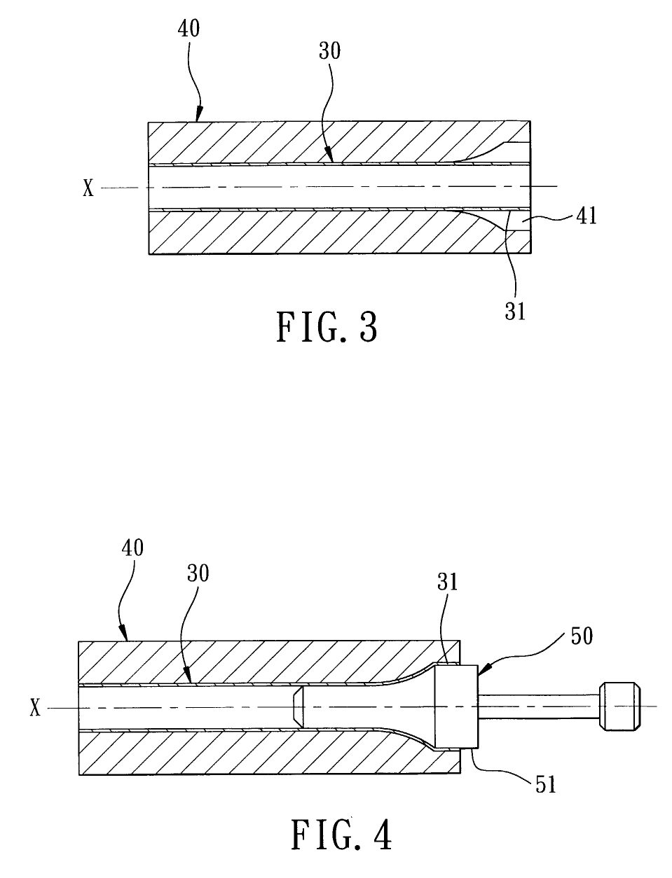

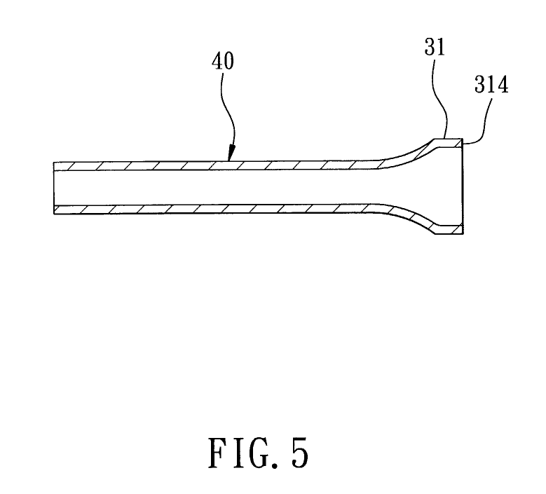

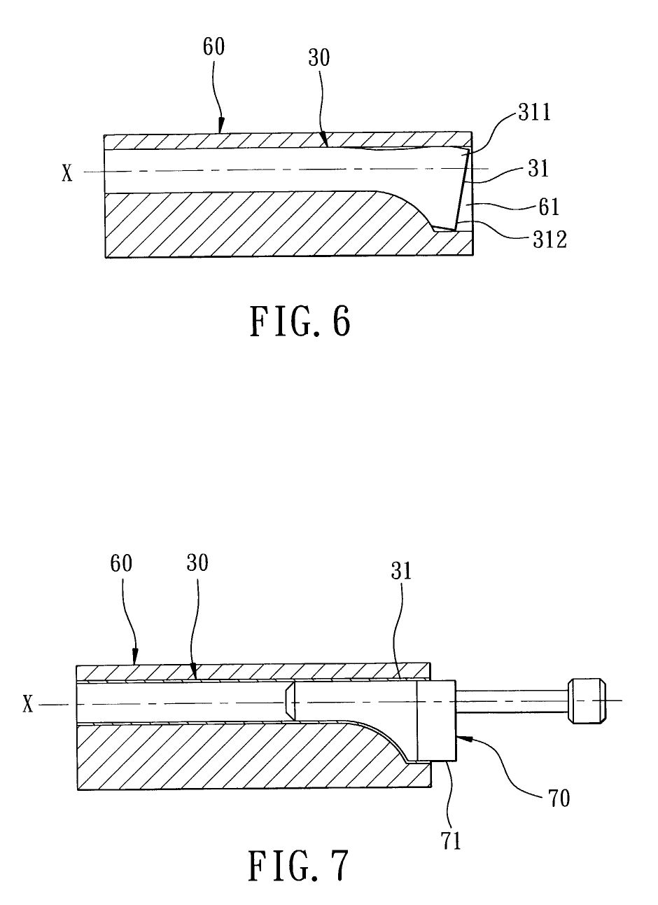

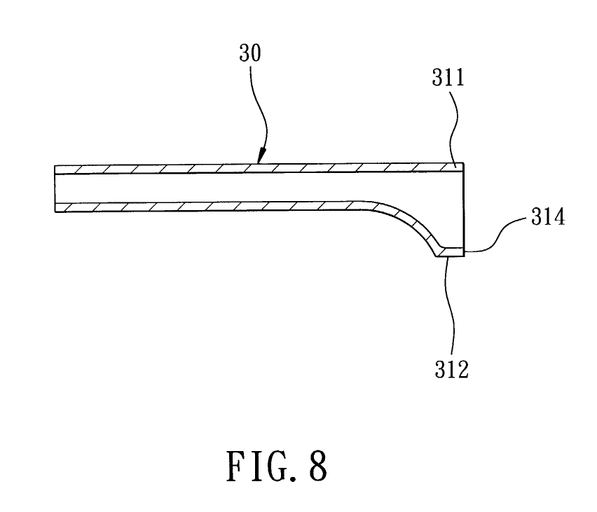

FIGS. 2 to 8 illustrate consecutive steps of a preferred embodiment of a multi-stage forging method of this invention for disproportionally enlarging an end section 31 of a tube 30 of a bicycle frame part (see FIG. 8). The method includes the steps of: (a) preparing first and second dies 40, 60 with end sections that respectively define first and second shape-forming cavities 41, 61, and first and second mandrels 50, 70 with shape-forming ends 51, 71 that have cross-sections respectively corresponding to those of the end sections of the first and second dies 40, 60 (see FIGS. 4 and 7); (b) inserting the end section 31 of the tube 30 into the first shape-forming cavity 41 as illustrated in FIG. 3; (c) radially and proportionally enlarging the cross-section of the end section 31 of the tube 30 relative to a centerline (X) of the tube 30 by forging the tube 30 in the first shape-forming cavity 41 with the shape-forming end 51 of the first mandrel 50 inserted into the end section 31 of the tube 30, as illustrated in FIGS. 4 and 5; and (d) disproportionally varying the cross-section of the end section 31 of the tube 30 by forging the tube 30 obtained in step (c) in the second shape-forming cavity 61 with the shape-forming end 71 of the second mandrel 70 inserted into the end section 31 of the tube 30, as illustrated in FIGS. 6 to 8. The end section 31 of the tube 30 is forged in step (d) in such a manner that a portion 311 of the cross-section of the end section 31 of the tube 30 is reduced and the remaining portion 312 of the cross-section of the end section 31 of the tube 30 is further enlarged (see FIGS. 5 and 6), and that the perimeter of an end edge 314 of the end section 31 of the tube 30 obtained after step (d) (see FIG. 8) is substantially equal to that of the end edge 314 of the end section 31 of the tube 30 obtained after step (c) and before step (d) (see FIG. 5).

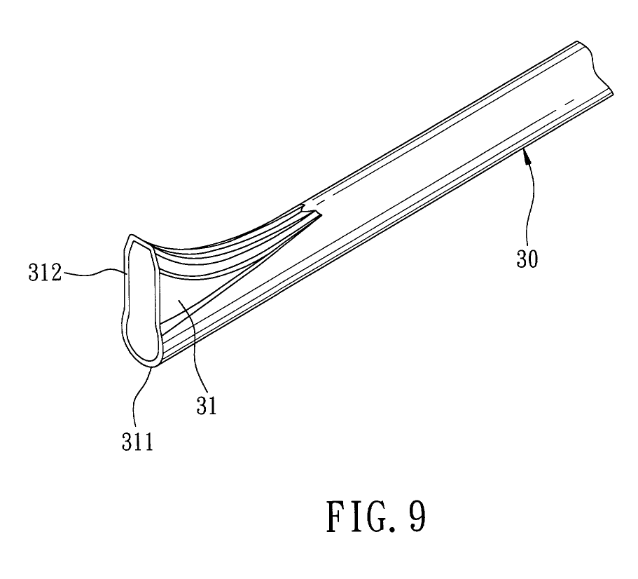

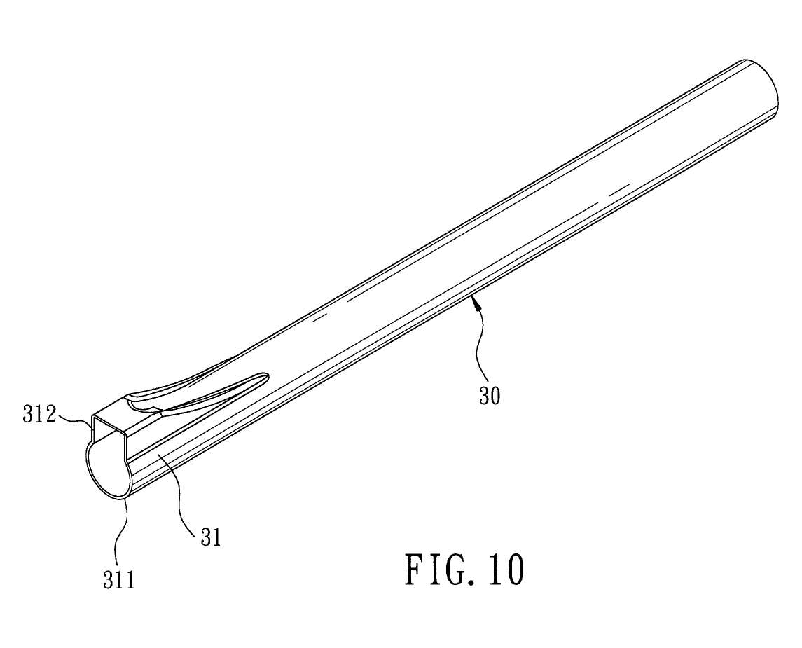

FIGS. 9 and 10 respectively illustrate various shapes of the end section 31 of the tube 30 of a bicycle frame part that can be formed according to the method of this invention.

The end section 31 of the tube 30, which is disproportionally enlarged according to the method of this invention, possesses a surface texture with regularly and gradually developed wrinkles that enhance the appearance of the tube 30.

With the invention thus explained, it is apparent that various modifications and variations can be made without departing from the spirit of the present invention. It is therefore intended that the invention be limited only as recited in the appended claims.

I claim:

1. A multi-stage tube forging method for disproportionally enlarging an end section of a tube, comprising the steps of:
(a) radially and proportionally enlarging the cross-section of the end section of the tube by forging the tube in a first die using a first mandrel; and
(b) disproportionally varying the cross-section of the end section of the tube by forging the tube obtained in step (a) in a second die using a second mandrel in such a manner that a portion of the cross-section of the end section of the tube is reduced and the remaining portion of the cross-section of the end section of the tube is further enlarged.

2. The multi-stage tube forging method of claim 1, wherein the perimeter of an end edge of the end section of the tube obtained after step (b) is substantially equal to that of the end edge of the end section of the tube obtained after step (a) and before step (b).

3. A bicycle frame part comprising a tube having an end section that is disproportionally enlarged according to a multi-stage tube forging method comprising the steps of:
(a) radially and proportionally enlarging the cross-section of the end section of the tube by forging the tube in a first die using a first mandrel; and
(b) disproportionally varying the cross-section of the end section of the tube by forging the tube obtained in step (a) in a second die using a second mandrel in such a manner that a portion of the cross-section of the end section of the tube is reduced and the remaining portion of the cross-section of the end section of the tube is further enlarged.

4. The bicycle frame part of claim 3, wherein the perimeter of an end edge of the end section of the tube obtained after step (b) is substantially equal to that of the end edge of the end section of the tube obtained after step (a) and before step (b).
